(19) United States
(12) Patent Application Publication
(10) Pub. No.: US 2026/0318475 A1
(43) Pub. Date: Oct. 15, 2026

(54) SUPPORT FOR COMPUTER HARDWARE

(71) Applicant: XFX Creation Inc., Hong Kong (CN)

(72) Inventor: Anwar MEMON, Ontario, CA (US)

(21) Appl. No.: 19/644,745

(22) Filed: Apr. 10, 2026

Related U.S. Application Data
(60) Provisional application No. 63/786,757, filed on Apr. 10, 2025.

(51) Int. Cl. F16M 13/02; G06F 1/185

(52) U.S. Cl. CPC F16M 13/02; G06F 1/185

(57) ABSTRACT

A support for computer hardware includes a single piece body with a bracket and a back plate coupled to and extending from the bracket. The bracket and back plate cooperate to define a cavity that has a size and a shape to receive a graphics processing unit. The single piece construction of the support provides additional support for the graphics processing unit and resistance against bending or sagging of the graphics processing unit.

### BACKGROUND

### Technical Field

The present disclosure is generally directed to a support for computer hardware.

### Description of the Related Art

Supports for computer hardware are known. For example, a computer may include a chassis that receives various supports or fasteners to removably attach hardware to the chassis. Advancements in technology have created a need for increased computing power, which in turn has led to larger and heavier computer hardware. The larger, heavier computer hardware can bend, break, or otherwise cause damage to the corresponding supports that assist with connecting the hardware to the chassis. In some cases, damage can also be caused to the motherboard or other internal computer hardware. Accordingly, it would be beneficial to have a support for computer hardware that overcomes these and other deficiencies and drawbacks with known solutions.

### BRIEF SUMMARY

The present disclosure is generally directed to a support for computer hardware. The support includes a bracket and a back plate coupled to and extending from the bracket as a single, integral, unitary component. The bracket and back plate cooperate to define a cavity that has a size and a shape to receive a graphics processing unit (“GPU”). The bracket can be secured to a chassis or support frame of a computer with the integral backplate providing additional support for the graphics processing unit and resistance against bending or sagging of the graphics processing unit. In particular, the combination of the bracket and the back plate as a single piece unit makes it more difficult for the GPU to bend the metal or other material of the back plate away from the bracket relative to bending a conventional bracket alone. This solution also does not require any additional or separate structures to provide sufficient support for the GPU.

Additional features and advantages of the concepts of the disclosure are explained in more detail below with reference to the accompanying figures.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive implementations are described with reference to the following drawings, wherein like labels refer to like parts throughout the various views unless otherwise specified. The figures do not describe every aspect of the teachings disclosed herein and do not limit the scope of the claims.

FIG. 1A and FIG. 1B are photographs illustrating disadvantages with known computer hardware supports.

FIG. 2 is a schematic view of an implementation of a support for computer hardware according to the present disclosure.

FIG. 3 is a schematic view of an implementation of a support for computer hardware according to the present disclosure.

FIG. 4 is a schematic view of an implementation of a support for computer hardware according to the present disclosure.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide computer hardware support devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

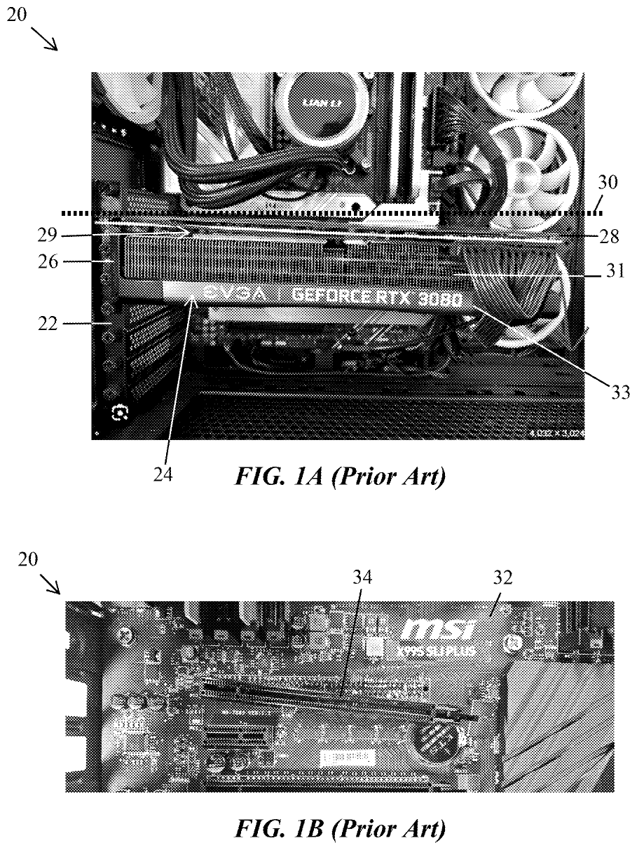

FIG. 1A and FIG. 1B are photographs of a known computer 20 that illustrate the deficiencies and disadvantages of current supports for computer hardware. Beginning with FIG. 1A, the computer 20 includes a chassis 22 that provides support for various hardware. The computer 20 includes a GPU 24. The GPU 24 may be coupled to the chassis 22 by a bracket 26. The bracket 26 is coupled to the chassis 22 by screws and supports the GPU 24. The GPU 24 further includes a back plate 28 that is a separate component from the bracket 26. The back plate 28 is typically on top of the GPU 24 and thus may also be referred to as a top plate. The back plate 28 may be metal and primarily assists with dissipating heat as well as preventing intrusion of contaminants to the GPU 24. Alternatively, the back plate 28 may be a plastic cover that protects a printed circuit board (“PCB”) without a heat dissipating function. The back plate 28 may be optional and omitted in some GPU 24 designs.

The GPU 24 may also include from top to bottom, the back plate 28, a PCB 29 directly attached to the back plate, a heat sink 31 including fins and pipes, and a cover or shroud 33. The heat sink 31 and the shroud 33 are a substantial majority (approximately 95% or more) of the thickness and weight of the overall GPU 24. As further explained below, the bracket 26 is insufficient to support the weight of the overall GPU 24, especially as GPUs increase in size and weight with technological developments.

Because the bracket 26 is positioned at only one end face (i.e., a left end face or side) of the GPU 24, the weight of the GPU 24 is cantilevered relative to the bracket 26 and chassis 22. The cantilevered nature of the support provided by the bracket 26 results in all of the weight of the GPU 24, including several pounds attributable to the heat sink 31, being distributed to the relatively weak bracket 26 with a high amount of torque. Over time, this can result in weakening of the bracket 26 and the GPU 24 bending or sagging, as shown in FIG. 1A. The GPU 24 is also prone to snapping or breaking when moving or due to sharp impacts or forces, such as when shipping and handling the computer 20. Dashed line 30 is a horizontal line that is provided as a reference to the original, preferred installation position of the GPU 24. In FIG. 1A, the GPU 24 is bent from the original installation position represented by dashed line 30. This problem is applicable to various sizes of GPUs, but is particularly pronounced for larger, heavier GPUs. The same issue may also exist for other types of computer hardware beyond the GPU 24.

FIG. 1B is a photograph of the computer 20 without the GPU 24 that illustrates a motherboard 32 and a GPU slot 34 of the computer 20. The GPU 24 is electrically and communicatively coupled to the motherboard 32 via the slot 34 on the motherboard 32 and terminals (not shown) on the GPU 24. The bending or sagging of the GPU 24 shown in FIG. 1A can result in damage to the slot 34 and can cause the slot 34 to break or snap, thus requiring removal of the GPU 24 and replacement of the slot 34 and/or motherboard 32, among other repairs. This is illustrated in FIG. 1B where the slot 34 is significantly bent downward from its original, horizontal position (similar to line 30 in FIG. 1A). The bending or sagging of the GPU 24 can also loosen the connection between the terminals of the GPU 24 and the slot 34. The failure of the terminals of the GPU 24 to make full contact with the slot 34 can cause the GPU 24 to function improperly and result in glitchy, laggy graphics. Further, the bending or sagging of the GPU 24 can cause the thermal management aspects of the computer 20 to pull away from the GPU 24 (or the GPU 24 to pull away from the thermal management aspects), which can cause the GPU 24 to overheat.

One prior solution is to use a separate support device for the opposite side of the GPU 24 from the bracket 26 (i.e., the right side of the GPU 24) to distribute the weight of the GPU 24 to an additional support and alleviate some of the force applied to the bracket 26. The additional support may be a post or column that is placed and secured underneath the GPU 24. One issue with this approach is that it requires the purchase of a separate component, which increases costs for the consumer. Another drawback of this solution is that the separate support requires space in the computer 20, and particularly underneath the GPU 24, that may not always be available such that it is limited to a relatively narrow range of computer 20 architectures or layouts. It follows that it would be advantageous to have a support for computer hardware that overcomes these and other deficiencies and drawbacks associated with current solutions.

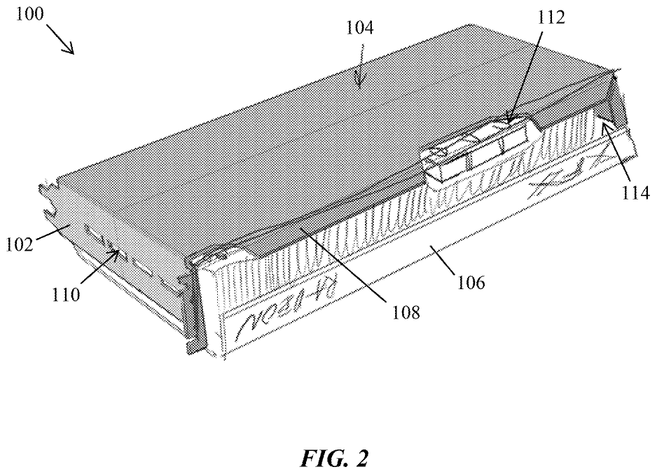

FIG. 2 is a schematic illustration of one or more implementations of a support for computer hardware 100 (“support 100”) according to the present disclosure. The support 100 is a single piece component including a bracket 102 and integrated back plate 104. The bracket 102 is couplable to a chassis or other support of a computer, as described herein. The back plate 104 is integral with the bracket 102 as a single, unitary component. Further, the support 100 as well as the bracket 102 and/or the back plate 104 has a size and a shape to receive a GPU 106. A size and a shape of the support 100 may be the same for each different size of GPU or may differ to accommodate different size GPUs. The bracket 102 may generally overlap and be aligned with one end face or side surface, such as a left end face, of the GPU 106.

The back plate 104 overlaps and is aligned with at least a top surface of the GPU 106. Further, the back plate 104 may extend to overlap an opposite end face or side surface, such as a right end face of the GPU 106. The back plate 104 may also have extensions 108 that extend outward from a front or rear surface of the GPU 106 and may partially overlap the same. The bracket 102 includes openings 110 to facilitate connection of cables or terminals to the GPU 106 through the bracket 102 and the support 102. A number, size, and shape of the openings 110 may be selected to fit standard sizes of cables or terminals. Additionally, a thickness of the bracket 102 and/or back plate 104 can be selected to provide sufficient support for the GPU 106 while also allowing cables or terminals to pass through the openings 110. The back plate 104 includes a connection aperture 112 that extends into the back plate to facilitate connection of the GPU 106 to the computer and/or motherboard. The connection aperture 112 may have a trapezoidal or other selected shape sufficient to facilitate a connection between the GPU 106 and the computer and/or motherboard. The GPU 106 may be secured to the support 100 through any available device, method, or system, including without limitation, adhesives, fasteners, additional brackets, and the like.

In an implementation, the bracket 102 is arranged vertically and generally parallel to the chassis to facilitate the connection between the two. The back plate 104 is a solid, continuous piece of material that is horizontal and extends perpendicular to the bracket 102 to assist with holding the GPU 106 in a horizontal position. The bracket 102 and the back plate 104 may be the same or a different material and may have the same or a different thickness. Further, each of the bracket 102 and the back plate 104 may be a sheet of material with opposing flat and planar major surfaces (i.e., surfaces with the largest surface area of any other surface) except as otherwise noted herein. The bracket 102 and the back plate 104 cooperate to define a cavity 114 or channel that receives the GPU 106. Further, the bracket 102 may generally have major surfaces with a smaller surface area than the major surfaces of the back plate 104. The larger size of the back plate 104 further helps prevent bending or sagging by adding additional supporting material directly above the GPU 106.

The single piece construction of the support 100 provides a number of advantages. The additional material of the combined bracket 102 and back plate 104 provides greater resistance against the force applied by the GPU 106 to prevent bending or sagging of the GPU 106 as in the above examples. For example, the bracket 102 and the back plate 104 may be metal or some other selected material. Thus, in order for the GPU 106 to bend or sag, the GPU 106 must bend the relatively strong and rigid metal of the back plate 104 away from the bracket 102 instead of bending or otherwise impacting the bracket 102 alone. Thus, the support 100 prevents bending or sagging of the GPU 106 by adding additional reinforcement to the bracket 102 via the integral back plate 104. Further, the support 100 being a single piece that has a size and shape of the GPU 106 allows for the support 100 to be integrated with the GPU 106 and occupy less space in the computer. Thus, the support 100 does not require additional space in the computer and can be used with a wider variety of architectures and layouts. Keeping the GPU 106 in the correct position via the support 100 also reduces or eliminates the connection issues and thermal management issues discussed above with known supports. Related methods to the devices and systems described herein are also contemplated, such as methods of installing and securing the GPU 106 and others. Further, while the above provides a specific example of a support for a GPU, other applications are contemplated herein, including at least a similar support sized and shaped for other computer hardware. Thus, the disclosure is not limited solely to a support for a GPU.

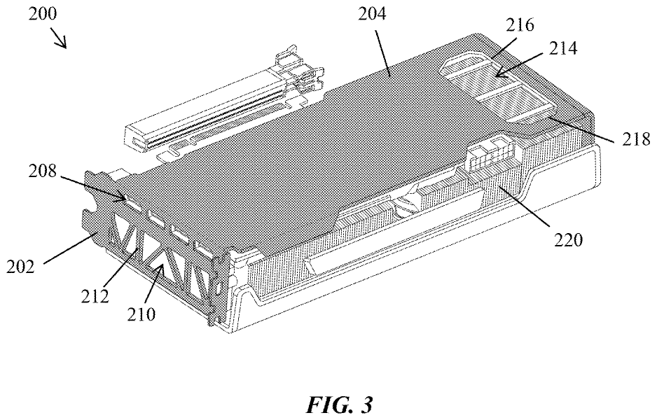

FIG. 3 is a schematic view of a further implementation of a support 200 according to the present disclosure. The support 200 may have any of the features described above for the support 100 and may likewise be a single, integral structure including a bracket 202 and a back plate 204. The support 200 differs from the support 100 in that the bracket 202 includes a lattice under openings 208 for receiving cables or terminals comprising apertures 210 separated by struts 212. The apertures 210 can be formed during manufacturing by stamping, cutting, etching, molding, or other techniques. As such, the apertures 210 can generally have a selected shape, although triangular apertures 210 are preferred for improved structural support.

The struts 212 are strips of material between the apertures 210 that delimit or define boundaries of the apertures 210. As shown in FIG. 3, the struts 212 can each have the same thickness and/or width while the orientation of the struts 212 to define the triangular apertures 210 results in some of the struts 212 having a different length than other struts 212. The dimensions of the struts 212 can also be selected and some struts 212 may differ from the other struts 212 in any dimensions. Selected ones of the struts 212 can be arranged vertically, horizontally, at a 45 degree angle to define a right triangle, or at a selected angle greater than 0 degrees and less than 90 degrees (i.e., any angle between horizontal and vertical). In addition, the apertures 212 may each have the same size (i.e., open area) or a different size, as shown in FIG. 3. The apertures 212 can be arranged in an overall rectangle pattern or combine to define a rectangle as in FIG. 3, or some other selected shape. In an implementation and as shown in FIG. 3, the triangular apertures 212 may include a central equilateral triangle surrounded by right triangles of varying shapes and sizes with the size of the right triangles generally decreasing with the distance from the center of the lattice. In other words, the outermost triangles in the lattice are smaller in size than the central equilateral triangle. The overall arrangement of the lattice including the apertures 210 and struts 212 provides structural support for the back plate 204 while the removal of material to form the apertures 210 reduces the overall weight of the support 200 while still providing sufficient structural strength for the bracket 202 and support 200 as a whole. The apertures 210 may also provide a heat dissipation function in some implementations.

In FIG. 3, the back plate 204 further includes a vent 214 that is an opening through the back plate 204 that may have a selected size and shape. The vent 214 of FIG. 3 is an octagon with major sides 216 and minor sides 218. The major sides 216 have a longer length than any other side and the total combined length of the major sides 216 may be greater than a sum of all the minor sides 218. As such, the vent 214 extends across a majority of the back plate 204 in a direction from the front face of a GPU 220 shown in FIG. 3 toward a rear or back face of the GPU 220 (i.e., a width direction). The vent 214 extends further in the width direction than in a length direction of the support (i.e., from left to right as shown in FIG. 3). The vent 214 is also located closer to one end, namely the right end in FIG. 3, than the opposite left end of the support 200. The vent 214 assists with dissipating heat generated by the GPU 220.

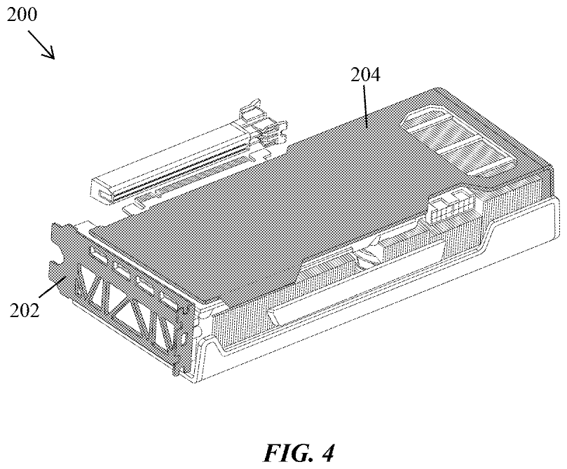

FIG. 4 is a schematic view of the support 200 that has the same features as in FIG. 3, except the bracket 202 and the back plate 204 are not integral as a single piece of material, but rather, are separate pieces. Where the bracket 202 and back plate 204 are separate, as in FIG. 4, the bracket 202 and back plate 204 may be separately coupled to the computer chassis or some other support of the computer without being coupled together. Alternatively, the two pieces can be joined together to form a single support including the bracket 202 coupled to the back plate 204.

Irrespective of whether the bracket 202 and back plate 204 are two pieces or a single piece, the back plate 204 is above and on top of the GPU 220 when mounted, the GPU or processor 220 is in the middle, and thermal fans are at the bottom (not shown). The back plate 204 is also a single, continuous piece of material in all implementations discussed herein. By having better leverage and mounting the GPU 220 using a single piece of material, preferably metal, on top of the GPU 220, the weight of the thermal fans at the bottom is prevented from pulling, tearing, and/or damaging the GPU 220 and memory. In other words, the single piece backplate 204 described herein overcomes the challenges faced in the industry with respect to preventing the weight of thermal fans associated with GPUs, and in particular larger GPUs, from damaging internals of a computer and the GPU itself.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied outside of the computer hardware support context, and are not limited to the example systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with computer hardware support devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, plastic compounds, glass, wood, and the like, either alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A support for computer hardware, comprising:
a body being a single piece and including a bracket and a back plate integral with the bracket,
wherein the bracket is configured to be secured to a chassis of a computer and the body is configured to receive and support a graphics processing unit via the bracket and the back plate.

2. The support of claim 1, wherein the bracket and the back plate are perpendicular to each other.

3. The support of claim 1, wherein the bracket is a sheet of material with opposing flat and planar major surfaces.

4. The support of claim 3, wherein the back plate is a sheet of material with opposing flat and planar major surfaces.

5. The support of claim 1, wherein the bracket includes at least one opening configured to receive a cable or terminal.

6. The support of claim 1, wherein a surface area of the bracket is less than a surface area of the back plate.

7. The support of claim 1, wherein the back plate is a solid and continuous layer of material.

8. The support of claim 1, wherein the bracket and the back plate cooperate to define a cavity having a size and a shape to receive the graphics processing unit.

9. A support for computer hardware, comprising a bracket and a back plate coupled to the bracket as a single, integral, unitary component configured to receive and secure a graphics processing unit to a support frame of a computer.

10. The support of claim 9, wherein the bracket includes a lattice having openings separated by struts.

11. The support of claim 9, wherein the back plate includes a vent.

12. The support of claim 11, wherein the vent extends across a majority of a width direction of the back plate.

13. The support of claim 11, wherein the vent is located closer to one side of the back plate than to an opposite side of the back plate.

14. A device, comprising:
a bracket; and
a back plate, wherein the back plate is a single continuous piece of material, and
wherein the bracket and the back plate cooperate to define a space to receive and support a graphics processing unit.

15. The device of claim 14, wherein the bracket and the back plate are separate pieces.

16. The device of claim 14, wherein the back plate includes a vent having major sides and minor sides, wherein a combined length of the major sides is greater than a sum of a length of all of the minor sides.

17. The device of claim 14, wherein the bracket includes a lattice having apertures separated by struts.

18. The device of claim 17, wherein the apertures are triangles.

19. The device of claim 17, wherein the struts are arranged at an angle to horizontal greater than and excluding 0 degrees and less than and excluding 90 degrees.

20. The device of claim 14, wherein a central aperture of the apertures is an equilateral triangle.
